(19) United States
(12) Patent Application Publication
(10) Pub. No.: US 2018/0168779 A1
(43) Pub. Date: Jun. 21, 2018

(54) ANCHORING SYSTEM FOR PROSTHETICS

(71) Applicants: Sten R. Gerfast, Mendota Heights, MN (US); Christopher J. French, Eagan, MN (US)

(72) Inventors: Sten R. Gerfast, Mendota Heights, MN (US); Christopher J. French, Eagan, MN (US)

(21) Appl. No.: 15/530,286

(22) Filed: Dec. 19, 2016

(51) Int. Cl. A61C 8/00; A61D 5/00; A61C 13/15; A61C 13/00; A61C 13/083

(52) U.S. Cl. CPC A61C 8/0036; A61C 8/0075; A61D 5/00; A61C 8/0074; A61C 2008/0046; A61C 8/0016; A61C 13/0019; A61C 13/0004; A61C 13/0835; A61C 19/003

(57) ABSTRACT

This invention is a new single piece dental prosthetic,
a root section connected to the decorative crown section, becoming one part,
with a bifurcated root for better anchoring and cleaning action,
characterized by:
   Its simplicity makes it less expensive, and affordable by persons of limited means.
   Simpler, easier implementation than previous systems.
   This reliable system provides a new type of anchoring.

The present invention is a reliable system with several fastening systems.

It is also new way to make an implant less costly,
and therefore more affordable by poor persons of low income status.

This is done by simplifying the above mentioned procedures,
and using new method's such as bifurcation and circular ridge fastening.

### BACKGROUND OF THE INVENTION

This invention is a new single piece dental prosthetic,

a root section connected to the decorative crown section, becoming one part,
with a bifurcated root for better anchoring and cleaning action,
characterized by:
Its simplicity makes it less expensive, and affordable by persons of limited means.
Simpler, easier implementation than previous systems.
This reliable system provides a new type of anchoring.

The present invention is a reliable system with several fastening systems.

It is also a new way to make an implant less costly,

and therefore more affordable by poor person of low income status.

This is done by simplifying the above mentioned procedures,

and using new method's such as bifurcation and circular ridge fastening.

The previous available prosthetic systems are characterized by a two part system,

with a foundation part generally inserted by a screw-type force into the bone or tissue.

This operation is mostly performed by an oral surgeon, a complex and expensive procedure. After the procedure a substantial time period of healing is required, involving normally the patient's re-visit. The secondary operation, of a prosthetic system, is to attach a decorative tooth part, again generally done by a screw-type force,

by an additional Doctor or Dentist. Again keeping in mind the substantial time spent by both these professionals, and the very expensive components used,
making the present Dental Implant system so expensive
that it is out of reach for the average person, and is only available to the very rich.

Both of these procedures also involves the patient's extended time

and loss of work hours, as well as pain.

### DESCRIPTION OF THE INVENTION

The present invention is basically a way to make an implant less costly,

and therefore affordable by poor persons of low income status.

This is done by simplifying the above mentioned procedures. If the patient is needing a prosthetic in the areas that are not visible, such as molars, hidden or back teeth

the simplest way of doing an implant is this inventions “one piece implant”.

It is constructed of a suitable material with a basic shape as a

one piece tapered root part below the gum line
continuing into a crown part visible above the gum line.

It can be made from a solid metal part. If the dental prosthetic root section is bifurcated into two bendable legs the legs can be adjusted into dual roots, making it possible

to push into, and be used on a dual root system which are exposed by an extraction. Similarly, the two bendable legs can be bent into a bow leg, pushed into a single root system, giving the prosthetic a hollow that provides for tissue and bone a place to grow into,
and for anchoring the prosthetic. If necessary to enlarge the cavity
a trephine tool can be used.

Another possibility is to adjust the length of the two bendable bifurcated legs

by snipping of the legs, to the case specific required length, using commonly available tools. These kind of tools is available both in a machinist tool company,
as well as in a dental supply house. If necessary, filing or buffing removes the burrs.

The least expensive way to make the dental prosthetic is by ordering them from

a Screw Machine Company which automatically turn and cut the length
by mass production. A bifurcated operation can also be done inexpensively.

If so ordered, in titanium or stainless steel material,

the cost of each prosthetic is less than $1.00.

This invention also includes a similar structure but in a dual part configuration,

where the root section has a threaded center section suitable for insertion of
a decorative crown section. This version is suitable for visible teeth. The crown section
is screwed into a threaded portion and secured.

This dual part configuration does not preclude a bifurcated Design.

With the simplification described here, it makes it possible to complete the prosthetic

and follow-up procedures in one sitting. This again makes the present invention
much more affordable for persons with limited means.

One way to retain the dental prosthetic firmly in its position, is to have a circular

female indentation towards to the top of the prosthetic, with a corresponding
circular female indentation in the cavity that will receive it. These two indentations can be filled with the appropriate type of adhesive such as UV curable or other resins.

### DESCRIPTION OF THE DRAWINGS

FIG. 1 is describing a prosthetic with a hollow spherical indent.

FIG. 2 is describing a trephine drill.

FIG. 3 is describing a prosthetic root section combined with a decorative crown section.

FIG. 4 is describing another method of combining the root and crown.

FIG. 5 is describing how to securely mount the root and crown prosthetic.

### DETAILED DESCRIPTION OF THE DRAWINGS

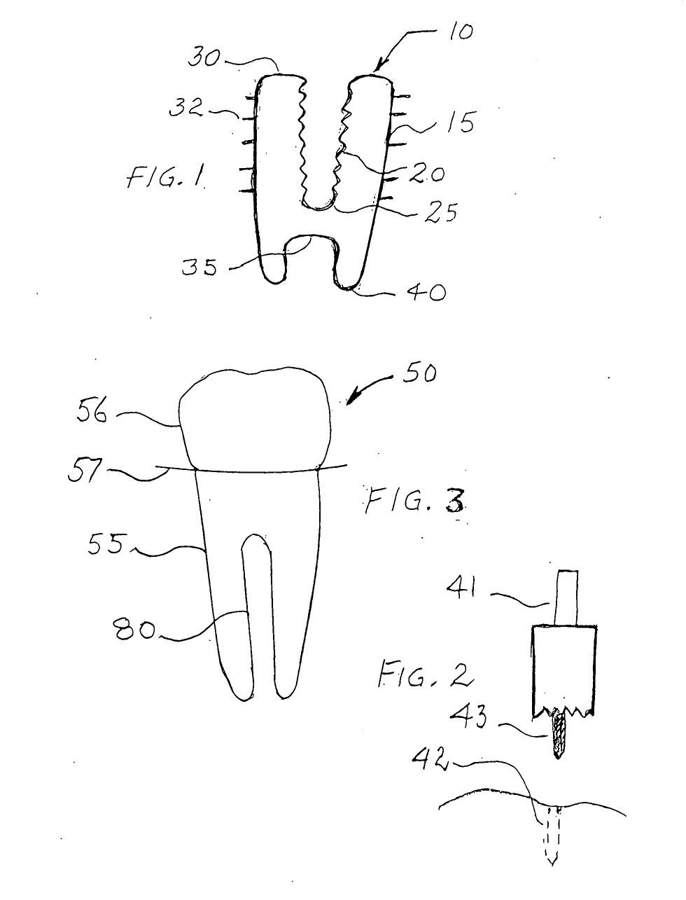

FIG. 1 is describing a prosthetic 10 with a hollow spherical indent 35, also having a tapered rounded bottom legs 40. Towards the top of its cylindrical profile 15 it is having external cylindrical ribs or helical ribs 32, and an internal thread structure 20. Its top portion can have a rounded or flattened structure.

FIG. 2 is showing how a cavity, needed for the prosthetic, is done with a trephine tool.

This surgically created cavity can be done with a trephine tool 41 or other bore.

To locate where the cavity is to be placed, it is very helpful to drill a guide hole 42.

To effectively center the trephine tool 41 in this guide hole, a center post 43 in the tool have been found to provide excellent placement and very good qualities of cavities.

FIG. 3 is a view 50 which is showing how a hollow spherical indent (35 in FIG. 1)

can be extended into a bifurcated opening 80 which is the root sections bifurcation.

The tapered sides of the root 55 is continuing into a decorative section 56

combining the two parts into one, making it a single part prosthetic.

The decorative section, which is also the crown part 56, is visible above the gum line 57. FIG. 4 is showing how a tapered 55 bifurcated 80 root prosthetic can have a decorative portion 56 attached with a screw type attachment 58. A possible join line 59 is shown

where the two parts would be combined. The decorative portion 56
can be of the same material, or with another suitable material as stated in the Claims.

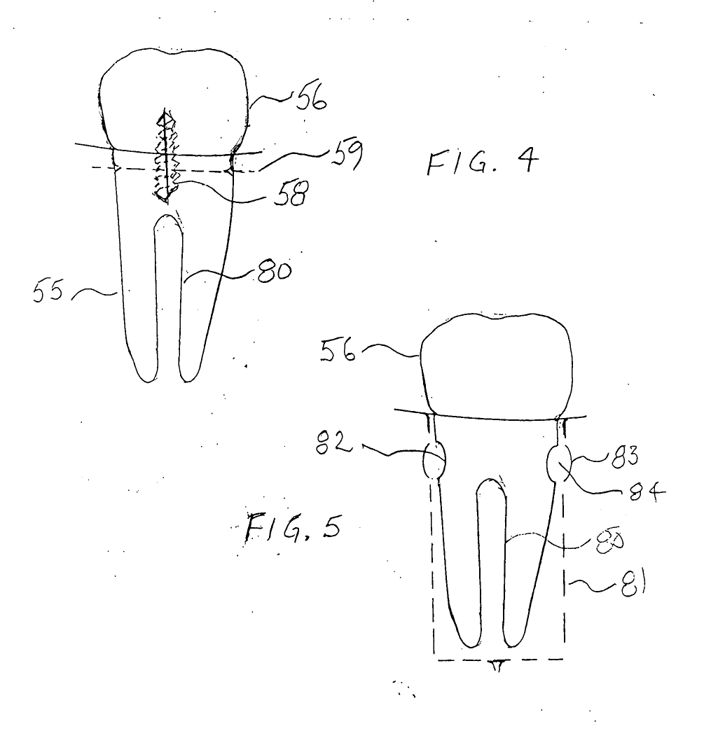

FIG. 5 is showing a different form of retention of the dental prosthetic with bifurcation 80, showing how it is held firmly in its position in a cavity 81, specifically

right after that it has been placed.

It is to have a circular female indentation 82 made towards to the top of the prosthetic,

with a corresponding circular female indentation 83 in the cavity 81 that will receive it.

The cavity 81 can be an extraction cavity, or trephine tool cavity.

The two indentations 82 and 83 can be filled with the appropriate type of adhesive 84,

such as UV curable or other resins. Both the UV type and other adhesives like
cyano-acrylate are almost instant setting.

The circular female indentation in the 83 cavity is accomplished

with a circular (spherical) dental burr.

A logical combination of the above figures,

would make additional prosthetic forms and attachments.

1. An anchoring system for a dental prosthetic comprising: a prosthetic's root section combined with the prosthetic's crown section into a single cost-effective prosthetic part, wherein the crown section is the only visible part above
the a human gum line, when the prosthetic part is placed in an extraction cavity in the jaw,
the prosthetic made by mass production by a screw-machine for less than one dollar,
into a bendable, prosthetic,
thereby making the prosthetic non-personalized, and much less expensive then prior art,
with the root section having a bifurcated tapered root, and with the prosthetic parts
made from appropriately selected material compatible with bone and tissue,
the prosthetic inserted by force or screw type motion into an existing
or surgically made dental cavity in the human or animal body.

2. An anchoring system for a dental prosthetic comprising:
a prosthetic's tapered root section having an internal thread structure,
used for attaching to a decorative crown section, making a combined prosthetic,
wherein the root section is made bifurcated into two bendable legs,
and the prosthetic made from appropriately selected material,
compatible with bone and tissue, and the prosthetic inserted by force or screw type motion into an existing extraction cavity or surgically made dental cavity in the human or animal body.

3. An anchoring system for a dental prosthetic comprising:
a prosthetic's root section combined with the prosthetic's crown section
into a single cost-effective prosthetic part,
made by mass production by a screw-machine into a bendable, prosthetic,
thereby making the prosthetic, non-personalized, and much less expensive then prior art,
wherein the root section is made with peripheral grooves and into two bendable legs,
the prosthetic having circular peripheral grooves located on its upper parts,
and corresponding circular grooves in a human or animal cavity,
filling both grooves with UV curable material, exposing with UV rays,
wherein the cured and hardened materials anchors the prosthetic,
when the prosthetic part is placed in the jaw, in an extraction cavity,
the prosthetic part is made from appropriately selected material,
compatible with bone and tissue, and the prosthetic inserted by force or screw
type motion into an existing or surgically made dental
cavity in the human or animal body, in an extraction cavity, or trephine cavity.

4. An anchoring system for a dental prosthetic according to claim 3
wherein the root sections bifurcated two bendable legs is providing dual side passages,
and openings, for a clean out function for bacteria, blood and debris,
using the natural cleansing action of the body.

5. An anchoring system for a dental prosthetic according to claim 3
wherein the root sections two bendable legs are to be adjusted into dual roots,
bent into a bow leg condition or cut to appropriate length, for an extraction cavity, or trephine cavity.

6. An anchoring system for a dental prosthetic comprising:
a prosthetic's tapered root section having an internal thread structure,
attached to a decorative crown section, wherein the root section
is bifurcated bendable into two bendable legs,
and the prosthetic is made from appropriately selected material,
the prosthetic made by mass production by a screw-machine for less than one dollar,
the prosthetic is compatible with bone and tissue, and the prosthetic inserted by force
or screw type motion into an existing extraction cavity or surgically made
dental cavity, and the prosthetic is then placed in a human or animal body.

7. An anchoring system for a dental prosthetic according to claim 1
wherein the root section is cost effectively mass produced for one dollar, as
bifurcated, by a bifurcating operation into two bendable legs.

8. An anchoring system for a dental prosthetic according to claim 3
wherein the root sections two bendable legs are to be adjusted into dual roots,
bent into a bow leg condition or adjusted and cut to appropriate length.

9. An anchoring system for a dental prosthetic according to claim 1 wherein
the root section and decorative part are made from appropriate material, or from solid metal.

10. (canceled)

11. (canceled)

12. An anchoring system for a dental prosthetic according to claim 3
wherein, in addition to other adhesives, are using
compounds of the cyanoacrylate family.

13. An anchoring system for a dental prosthetic according to claim 3
wherein peripheral bifurcated grooves is providing tissue and bone
a place to grow into and thereby anchoring the prosthetic in the jaw.

14. An anchoring system for a dental prosthetic according to claim 1
wherein the root section or upper part decorative section is produced by 3D printing,
by 3D appropriate material, or from solid metal.

15. An anchoring system for a dental prosthetic according to claim 3 wherein,
the root section or decorative upper section is
computer machined using ceramic-resin.
a compound of nano-ceramic particles embedded in a resin matrix,
using cad-cam type programs.

16. An anchoring system for a dental prosthetic according to claim 2
wherein the material of the prosthetic is titanium, stainless steel, or precious metal,
with all the above metal materials allowing bending and cutting.
